(19) United States
(12) Patent Application Publication
(10) Pub. No.: US 2016/0291897 A1
(43) Pub. Date: Oct. 6, 2016

(54) DATA STORAGE DEVICE AND DEVICES HAVING THE SAME

(71) Applicant: SAMSUNG ELECTRONICS CO., LTD., Suwon-si (KR)

(72) Inventors: Hae Sung BAE, Hwaseong-si (KR); Taek Kyun LEE, Suwon-si (KR); Hyun Ju KIM, Hwaseong-si (KR); Hwan Chung KIM, Namwon-si (KR); Young Woo JUNG, Gunpo-si (KR)

(73) Assignee: SAMSUNG ELECTRONICS CO., LTD., Suwon-si (KR)

(21) Appl. No.: 15/007,893

(22) Filed: Jan. 27, 2016

(30) Foreign Application Priority Data
Apr. 2, 2015 (KR) 10-2015-0046959

(51) Int. Cl. G06F 3/06

(52) U.S. Cl. CPC G06F 3/0637; G06F 3/0622; G06F 3/0673; G06F 3/0634

(57) ABSTRACT

A data storage device according to an exemplary embodiment includes: a non-volatile memory which includes a first region configured to store vendor data and a second region configured to store user data; and a memory controller configured to receive a first command from a host, determine whether there is a first ID of a program, which is allowed to access the first region, in the first command, and decide whether to enter a vendor mode for accessing the first region according to a result of the determination.

### CROSS-REFERENCE TO RELATED APPLICATION

This application claims priority from Korean Patent Application No. 10-2015-0046959 filed on Apr. 2, 2015, the disclosure of which is hereby incorporated by reference in its entirety.

### BACKGROUND

1. Field

Apparatuses consistent with exemplary embodiments of the present inventive concept relate to a data storage device, and more particularly to a data storage device which uses an identification (ID) of a process that can enter a vendor mode and allows only the process having the ID to use a vendor mode service, and devices having the same.

2. Description of the Related Art

A multimedia card (MMC) is a memory card standard of a flash memory. An embedded multimedia card (eMMC) is a standard for an embedded MMC defined as a standard in the Joint Electron Device Engineering Council (JEDEC).

When an eMMC receives a read command or a write command from a host in a vendor mode, the eMMC may transmit or receive vendor data to or from the host. In a vendor mode of the eMMC, even if the eMMC receives a read command from a process in which the eMMC does not enter a vendor mode, the eMMC may read vendor data stored in a memory region in response to the read command output from the process, and transmit the vendor data which was read to the process.

Moreover, in the vendor mode of an eMMC, even if the eMMC receives a write command and write data from a process in which the eMMC does not enter the vendor mode, the eMMC may write the write data in a memory region for storing vendor data. That is, even a process which cannot enter the vendor mode can access the memory region for storing vendor data.

### SUMMARY

According to an exemplary embodiment, there is provided a data storage device which may include: a non-volatile memory which includes a first region configured to store vendor data and a second region configured to store user data; and a memory controller configured to receive a first command from a host, determine whether there is a first identification (ID) of a program, which is allowed to access the first region, in the first command, and decide whether to enter a vendor mode for accessing the first region according to a result of the determination. The first command may include a vendor mode indicating command and a vendor mode entry command, and the first ID may be included in one of the vendor mode indicating command and the vendor mode entry command.

The memory controller may receive a second command from the host, determine whether there is the first ID of the program in the second command, and decide whether to allow access of the program to the first region according to a result of the determination.

The second command may include a sector count command including the number of sectors to write and a write command, and the first ID may be included in one of the third command and the write command. The sector count command may be CMD23, and the write command may be CMD25.

The memory controller may write first data generated by the program in the first region in response to determining that there is the first ID of the program in the second command, and write the first data in the second region in response to determining that there is not the first ID of the program in the second command. The second command may include a sector count command including the number of sectors to read and a read command, and the first ID may be included in one of the sector count command and the read command. The third command may be CMD23, and the read command may be CMD18.

The memory controller may read the vendor data stored in the first region according to a read command generated by the program and transmit the read vendor data to the host in response to determining that there is the first ID of the program in the second command, and in response to determining that there is not the first ID of the program in the second command, the memory controller may transmit the user data stored in the second region to the host according to the read command.

The program may be a program related to at least one of a firmware update of the data storage device, a patch file update of the data storage device, and a failure analysis of the data storage device.

The memory controller may receive a second command from the host, determine whether there is the first ID of the program which is allowed to access the first region in the second command, and decide whether to exit the vendor mode according to a result of the determination. The first command may include a vendor mode indicating command and a vendor mode exit command, and the first ID may be included in one of the vendor mode indicating command and the vendor mode exit command.

The data storage device may further include a memory configured to store a second ID, and the memory controller configured to decide to enter the vendor mode in response to determining that the first ID accords with the second ID stored in the memory.

Another an exemplary embodiment, there is provided a data storage device which may include: a memory including a first region configured to store vendor data and a second region configured to store user data; and a memory controller configured to receive a command generated from a process or program performed by a host connected to the data storage device, determine an attribute of the command, and selectively allow an access of the command to the first region or the second region depending on a result of the determination of the attribute of the command.

According to an exemplary embodiment, there is provided a data processing system which may include: a host; and a data storage device which is connected to the host, wherein the data storage device includes: a non-volatile memory device including a first region configured to store vendor data and a second region configured to store user data; and a memory controller configured to receive a first command from the host, determine whether there is a first ID of a program, which is allowed to access the first region in the first command, and decide whether to enter a vendor mode according to a result of the determination.

The first command may include a vendor mode indicating command and a vendor mode entry command, and the first ID may be included in one of the vendor mode indicating command and the vendor mode entry command.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a data processing system, according to an exemplary embodiment;

FIG. 2 is a specific block diagram of the data processing system show in FIG. 1, according to an exemplary embodiment;

FIG. 3 is a specific block diagram of a host described in FIG. 1, according to an exemplary embodiment;

FIG. 4 is a schematic block diagram of a configuration of a command to be transmitted to the data storage device, according to an exemplary embodiment;

FIG. 5 is a schematic block diagram to describe a write operation of the data storage device shown in FIG. 2, according to an exemplary embodiment;

FIG. 6 is a schematic block diagram to describe a read operation of the data storage device shown in FIG. 2, according to an exemplary embodiment;

FIG. 7 is a timing diagram of data, a command, and a clock signal received by the data storage device in the write operation of FIG. 5, according to an exemplary embodiment;

FIG. 8 is a timing diagram of data, a command, and a clock signal received by the data storage device in the read operation of FIG. 6, according to an exemplary embodiment;

FIG. 9 is a schematic block diagram for a write operation of a data storage device in a vendor mode, according to another exemplary embodiment;

FIG. 10 is a schematic block diagram of a read operation of a data storage device, according to another exemplary embodiment;

FIG. 11 is a data flow for a write operation of a data storage device, according to still another exemplary embodiment;

FIG. 12 is a data flow for a read operation of a data storage device in the vendor mode, according to still another exemplary embodiment;

FIG. 13 is a flow chart which shows an exemplary embodiment of a method of operating the data storage device, according to an exemplary embodiment;

FIG. 14 is a flow chart which shows another exemplary embodiment of the method of operating the data storage device, according to an exemplary embodiment; and

FIG. 15 is a block diagram of a data processing system, according to another exemplary embodiment.

### DETAILED DESCRIPTION OF THE EXEMPLARY EMBODIMENTS

The present specification includes contents of an embedded multimedia card (eMMC) 5.0 specification provided at http://www.jedec.org as reference. Accordingly, as long as not differently defined in the present specification, terms the same as terms defined in the eMMC 5.0 specification should be understood in the same sense.

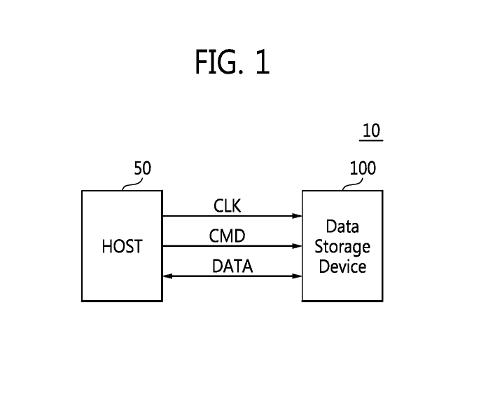

FIG. 1 is a schematic block diagram of a data processing system according to an exemplary embodiment. Referring to FIG. 1, a data processing system 10 may include a host 50 and a data storage device 100. The data processing system 10 may be embodied in a personal computer (PC), a laptop computer, a mobile phone, a smart phone, a tablet PC, a personal digital assistant (PDA), an enterprise digital assistant (EDA), a digital still camera, a digital video camera, an audio device, a portable multimedia player, a personal navigation device or portable navigation device (PND), an MP3 player, a handheld game console, a mobile internet device (MID), a wearable computer, an internet of things (IoT) device, an internet of everything (IoE) device, or an e-book.

The host 50 may control data processing operations of the data storage device 100, e.g., a vendor mode entry operation, a data read operation, a data write operation, and/or a vendor mode exit operation. The host 50 may mean a central processing unit (CPU), a processor, a microprocessor, an integrated circuit (IC), a system on chip (SoC), an application processor (AP), or a mobile AP.

The data storage device 100 may be connected to the host 500 through an interface for a data communication. The host 50 may transmit a clock signal CLK, a write command CMD, and/or write data DATA to the data storage device 100 through the interface. Moreover, the host 50 may receive read data DATA transmitted from the data storage device 100 according to a read command CMD.

The data storage device 100 may be embodied in a flash memory-based data storage device. For example, the data storage device 100 may be embodied in a solid state drive (SSD), a smart card, a secure digital (SD) card, a multimedia card (MMC), an embedded MMC (eMMC), an embedded multi-chip package (eMCP), a Perfect Page NAND (PPN), or a universal flash storage (UFS), without being limited thereto. For example, the flash memory-based data storage device may be embodied in a NAND-type flash memory or a NOR-type flash memory.

The host 50 may generate a command CMD which can control an operation of the data storage device 100. For example, the command CMD may be a vendor mode indicating command for indicating a vendor mode, a vendor mode entry command for an entry into the vendor mode which can access vendor data, a vendor mode exit command for ending the vendor mode, a read command for controlling a data read operation, a write command for controlling a data write operation, and/or an erase command for controlling a data erase operation.

Time (or an operation) taken until a completion of a command CMD after receiving the command CMD output from the host 50 by the data storage device 100 may be defined as a “mode”. For example, time or an operation taken until a completion of processing about vendor data after receiving a vendor mode command from the host 50 may be defined as a “vendor mode”.

According to an exemplary embodiment, two or more modes may be performed at the same time or in parallel. For example, while read data are transmitted from the data storage device 100 to the host 50 (for example, a read mode) after a read command is issued (or output) to the data storage device 100, the data storage device 100 may receive a write command output from the host 50 (for example, a write mode).

The host 50 may change a mode of the data storage device 100 by transmitting different commands CMD to the data storage device 100. For example, after the data storage device 100 enters the write mode while the host 50 issues a write command to the data storage device 100, write data are completely transmitted from the host 500. While the host 50 issues a read command to the data storage device 100, the data storage device 100 may enter the read mode.

The data storage device 100 may support a vendor mode which can use unique functions of the data storage device 100. The vendor mode collectively refers to a mode for reading or writing data that a vendor of the data storage device 100 wants. Examples of the vendor mode include a patch update mode for changing a patch file stored in the data storage device 100, a firmware update mode for updating a firmware program stored in the data storage device 100, and a failure analysis mode for a failure analysis of the data storage device 100, not being limited thereto.

The data storage device 100 may enter the vendor mode according to a vendor mode entry command. The data storage device 100 may enter a vendor mode according to a general command (for example, a write command or a read command) which is not a vendor command, or according to vendor mode entry information included in the write data.

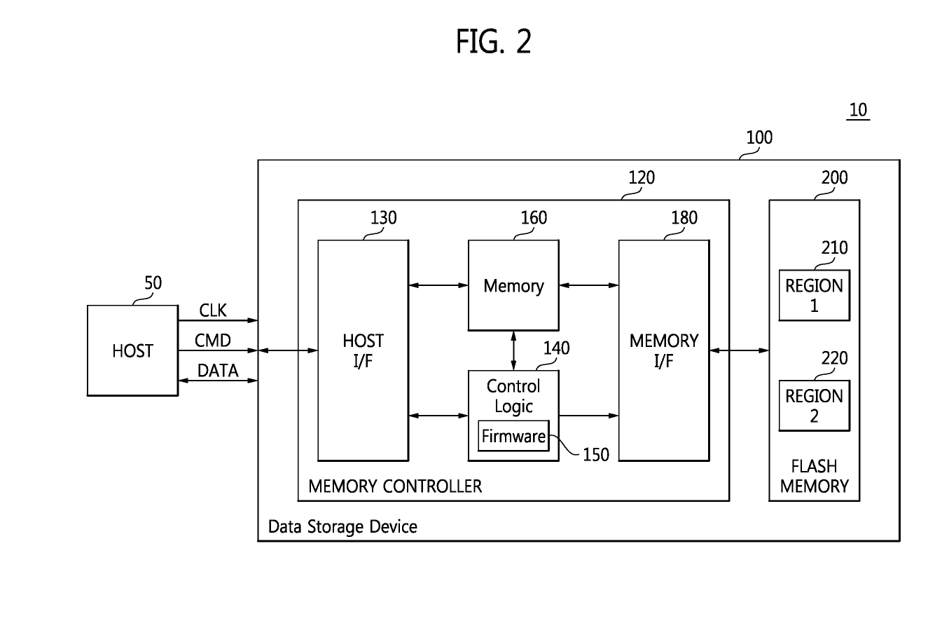

FIG. 2 is a specific block diagram of the data processing system shown in FIG. 1. Referring to FIGS. 1 and 2, the data storage device 100 may include a memory controller 120 and a non-volatile memory, e.g., a flash memory 200. Even if the flash memory 200 is exemplified as an embodiment of the non-volatile memory device; the inventive concept is not limited thereto, and thus, the flash memory 200 may be replaced by other types of non-volatile memory such as a ferroelectric random-access memory (FRAM), magnetoresistive random-access memory (MRAM), etc.

The flash memory 200 may include a plurality of flash memory chips or a plurality of flash memory packages. The flash memory 200 may be embodied in a NAND-type flash memory or a NOR-type flash memory.

The flash memory 200 may include a memory cell array. The memory cell array may include a two-dimensional (2D) memory cell array or a three-dimensional (3D) memory cell array. The 3D memory cell array is monolithically formed in one or more physical levels of array of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

According to an exemplary embodiment, the 3D memory cell array includes vertical NAND strings that are vertically oriented such that at least one memory cell is located over another memory cell. The at least one memory cell may comprise a charge trap layer.

The memory controller 120 may generally control the flash memory 200. The memory controller 120 may include a host interface 130, a control logic circuit 140, a memory 160, and a memory interface 180.

The host interface 130 may receive a command CMD and a clock signal CLK from the host 50 and control an input/output of data DATA according to a control of the control logic circuit 140. The host interface 130 may transmit the command CMD and the clock signal CLK transmitted from the host 50 to the control logic circuit 140. The host interface 130 may transmit the data DATA to the memory 160.

The host interface 130 may be embodied in a serial advanced technology attachment (SATA) interface, a SATA express (SATAe) interface, a serial attached small computer system interface (SCSI) interface, a peripheral component interconnect express (PCIe) interface, a non-volatile memory Express (NVMe) interface, an advanced host controller interface (AHCI) interface, or a multimedia card (MMC) interface, without being limited thereto.

The control logic circuit 140 may generally control the memory controller 120. A firmware 150 may be performed by the control logic circuit 140, and the firmware 150 may control various operations of the memory controller 120. The control logic circuit 140 may include at least one CPU. The firmware 150 may be stored or included in the CPU or any other part of the control logic circuit 140, or in the memory 160.

The firmware 150 may determine whether there is an identification (ID) of a process, which can access a memory region for storing vendor data, in a command CMD transmitted from the host 50. A process which is performed in the host 50 may be a program or an application program, without being limited thereto. For example, a process which can access a memory region for storing vendor data may be a program related to a firmware update, without being limited thereto.

The control logic circuit 140 may interpret the command CMD transmitted from the host 50, and transmit a result of the interpretation to the memory 160. For example, the control logic circuit 140 may receive the command CMD, extract a command argument of the command CMD, and check an ID included in the extracted command argument.

The firmware 150 performed by the control logic circuit 140 may determine whether the command CMD is output from a program which can access the memory region for storing vendor data. For example, the control logic circuit 140 may determine whether the command CMD includes an ID of the program which can access the memory region for storing vendor data.

The control logic circuit 140 may compare an ID previously stored in the memory 160 with an ID included in the command CMD, and output a result of the comparison. The control logic 140 may perform an operation corresponding to the command CMD according to a result of the comparison.

The memory 160 may store data DATA transmitted from the host interface 130 through the memory interface 180 or transmit the data DATA to the flash memory through the memory interface 180 according to a control of the control logic circuit 140. According to an exemplary embodiment, the memory 160 may store an ID output from the control logic circuit 140.

The memory 160 may be embodied in a volatile memory. The volatile memory may be embodied in a random access memory (RAM), a static RAM (SRAM), a dynamic RAM (DRAM), a synchronous DRAM (SDRAM), a thyristor RAM (T-RAM), a zero capacitor RAM (Z-RAM), or a Twin Transistor RAM (TTRAM). Even if the memory 160 is shown in the memory controller 120 in FIG. 2, but when the memory 160 is embodied in a DRAM, the memory 160 may be embodied outside the memory controller 120.

Moreover, the memory controller 120 may be embodied in a package, for example, a package on package (PoP), which includes components 130, 140, 160, and 180.

The memory 160 may store a mapping table for logical address-physical address conversion, and when the firmware 150 performed by the control logic circuit 140 is a flash translation layer (FTL), the FTL may perform logical address-physical address conversion using the mapping table.

The memory interface 180 may transmit data DATA to the flash memory 200 or receive the data DATA from the flash memory 200 according to a control of the control logic circuit 140. The flash memory 200 may store the data DATA. For example, the flash memory 200 includes a first region 210 for storing vendor data and a second region 220 for storing user data. For example, the vendor data may be specific data required by the vendor of the data storage device 100, e.g., metadata. The first region 210 may be a region including single level cells, and the second region 220 may be a region including multi-level cells. The single level cell may store information of one bit and the multi-level cell may store information of two bit or more. The first region 210 may include multi-level cells which store data in a single level cell write manner.

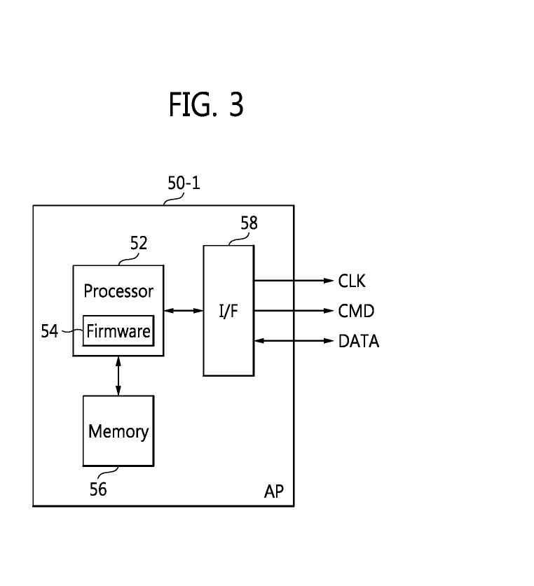

FIG. 3 is a specific block diagram of a host described in FIG. 1. Referring to FIGS. 1 to 3, a host 50-1 may be embodied in a host controller or an application processor 50-1. The host 50-1 may include a processor 52 which can perform a firmware 54, a memory 56, and an interface 58.

The processor 52 may generally control an operation of the host 50-1. The processor 52 may generate a command CMD to be transmitted to the data storage device 100. The processor 52 may insert, into the command CMD, an ID of a program which can access the first region 210 for storing vendor data.

The firmware 54 may be performed by the processor 52 and the firmware 54 may control various operations of the host 50-1. The firmware 54 may perform a program which can access the first region 210 for storing vendor data. The firmware 54 may generate the command CMD to be transmitted to the data storage device 100. The firmware 54 may insert, into the command CMD, an ID of the program which can access the first region 210 for storing vendor data.

The memory 56 may store the firmware 54 according to a control of the processor 52. According to another exemplary embodiment, the firmware 54 may alternatively be stored in the processor 52. The memory 56 may store the ID of the program which can access the first region 210 for storing vendor data. The interface 58 may transmit a clock signal CLK in addition to the command CMD to the data storage device 100. The interface 58 may transmit data DATA, e.g., write data, to the data storage device 100, and receive data DATA, e.g., read data, from the data storage device 100.

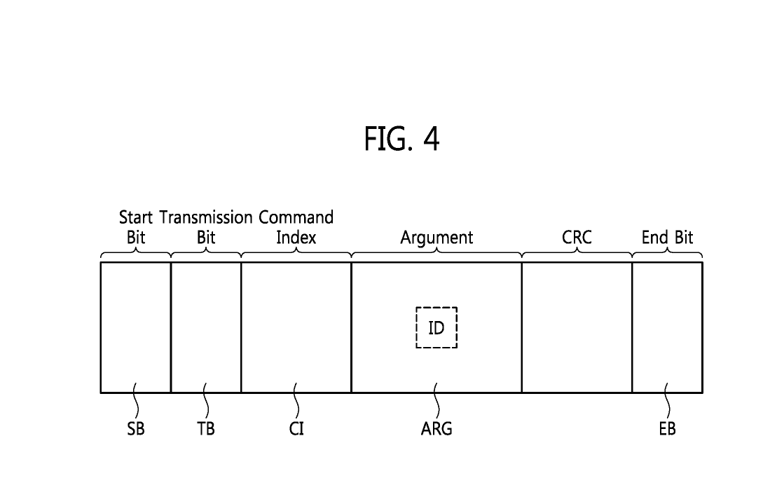

FIG. 4 is a schematic block diagram of a configuration of a command to be transmitted to the data storage device. Referring to FIGS. 1 to 4, a command CMD received by the data storage device 100 may be configured to include a start bit SB, a transmission bit TB, a command index CI, an argument ARG, bits for a cyclical redundancy check CRC, and an end bit.

The start bit SB is a bit which informs a start of the command CMD, the transmission bit TB is a bit which indicates a subject generating the command CMD, the command index CI may indicate a specific command among commands to be performed in the data storage device 100 as bits indicating a type of command.

For example, when the command index CI is CMD25, the command CMD may be a write command, and when the command index CI is CMD18, the command CMD may be a read command. Moreover, when the command index CI is CMD62, the command CMD may be a vendor mode command. Accordingly, the data storage device 100 may recognize which command is input according to a command index CI and perform an operation corresponding to the command index CI.

The argument ARG may include information needed to perform an operation corresponding to the command CMD. For example, when the command CMD is a read command or a write command, the argument ARG may include start address information of a memory cell array (not shown) of the flash memory 200 to be read (or written), and data size information of read data (or write data). The argument ARG may include an ID of a program running in the host 50. The ID may be set to at least one bit included in the argument ARG.

According to an exemplary embodiment, the argument ARG may include a first ID which shows a program accessing the first region 210 of the flash memory 200. Moreover, the argument ARG may include a second ID which indicates a program accessing the second region 210 of the flash memory 200. Here, “access” may mean a write operation or a read operation.

The CRC may be used to detect an error which can be generated during a transmission of the command CMD. An end bit EB may include at least one bit which informs an end of the command CMD. Referring to FIG. 2, the control logic circuit 140 may extract an argument ARG of the command CMD, analyze the extracted argument ARG, and perform one or more operations corresponding to a result of the analysis. For example, the control logic circuit 140 may determine whether to enter a vendor mode for a program, and the program may determine whether the program is to access the first region 210.

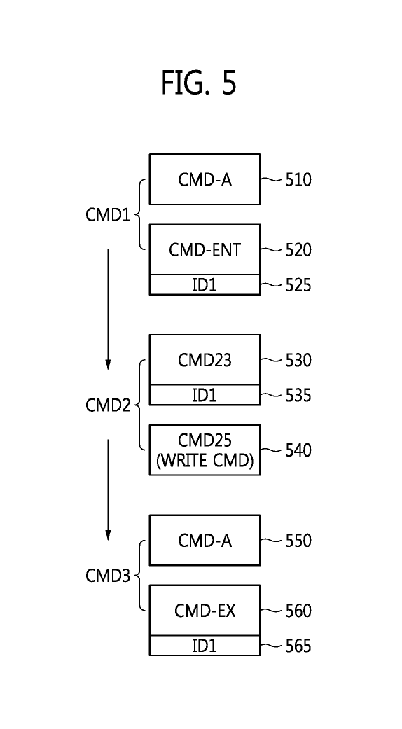

FIG. 5 is a schematic block diagram to describe a write operation of the data storage device 100 shown in FIG. 2. FIG. 5 shows commands CMDs received by the data storage device 100 when a write operation is performed in the data storage device 100 in a vendor mode according to an exemplary embodiment. Referring to FIGS. 2 to 5, the host 50 may transmit a first command CMD1 to the data storage device 100. The first command CMD1 may be a command for performing the vendor mode by a program performed in the host 50. The first command CMD1 may include a vendor mode indicating command 510 and a vendor mode entry command 520.

The vendor mode indicating command 510 may indicate that a command to be transmitted to the data storage device 100 is a vendor mode command. For example, a specific (or detail) operation for the vendor mode may be determined according to a command to be received after the vendor mode indicating command 510. The vendor mode entry command 520 may be a command for causing the data storage device 100 to enter the vendor mode.

The first command CMD1 may be determined by a vendor of the data storage device 100. For example, the first command CMD1 may be defined as CMD62, without being limited thereto. The vendor mode entry command 520 included in the first command CMD1 may include a first ID ID1 525 which indicates a program accessing the first region 210 for storing vendor data. Even if it is shown that the vendor mode entry command 520 includes the first ID ID1 525 in FIG. 5, the inventive concept is not limited thereto. That is, the first ID ID1 525 may be included in one of the vendor mode indicating command 510 and the vendor mode entry command 520.

The data storage device 100 determines whether there is the first ID ID1 525 in the first command CMD1, and when it is determined that there is the first ID ID1 525, the data storage device 100 may enter the vendor mode. After the data storage device 100 enters the vendor mode, the data storage device 100 may receive a second command CMD2 from the host 50.

The second command CMD2 may be a command for causing a program running in the host 50 to access vendor data. For example, the second command CMD2 may command an operation of writing the vendor data. The second command CMD2 may include a sector count command 530 including information about the number of sectors to be written in the data storage device 100 and a write command 540. The sector count command 530 may include information about a region of sectors in which the vendor data are to be written. The write command 540 may command writing the vendor data to a region defined by the sectors.

The second command CMD2 may be determined according to a type of the data storage device 100. When the data storage device 100 is embodied in an eMMC, the sector count command 530 may be CMD23, and the write command 540 may be CMD25. The sector count command 530 may include a first ID ID1 535 which indicates a program capable of accessing the vendor data.

Even if it is shown that the sector count command 530 includes the first ID ID1 535 in FIG. 5; the inventive concept is not limited thereto. That is, the first ID ID1 may be included in at least one of the sector count command 530 and the write command 540.

After the write operation is completed, the data storage device 100 may receive a third command CMD3 from the host 50. The third command CMD3 may indicate a vendor mode exit of the data storage device 100. The third command CMD3 may include a vendor mode indicating command 550 and a vendor mode exit command 560.

The vendor mode indicating command 550 may be substantially the same as or similar to the vendor mode indicating command 510 included in the first command CMD1. The vendor mode exit command 560 may be a command for the vendor mode exit (or end) of the data storage device 100. The data storage device 100 may determine whether a first ID ID1 565 is included in the third command CMD3, and when the first ID ID1 565 is included therein, the data storage device 100 may perform the vendor mode exit (or end).

Even if it is shown that the vendor mode exit command 560 includes the first ID 565 in FIG. 5, the inventive concept is not limited thereto. That is, the first ID ID1 565 may be included in at least one of the vendor mode indicating command 550 and the vendor mode exit command 560.

In the above, the first ID ID1 included in each of the first, second and third commands CMD1, CMD2 and CMD3 may include the same information about the program accessing the first region 210 for storing vendor data.

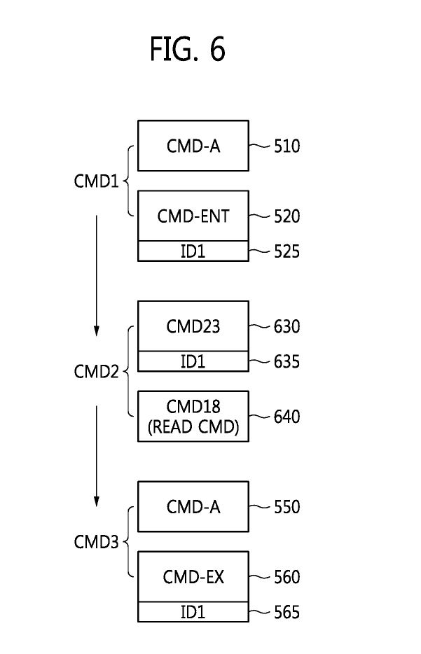

FIG. 6 is a schematic block diagram which describes a read operation of the data storage device shown in FIG. 2. Referring to FIGS. 5 and 6, except for the second command CMD2, each of the commands CMD1 and CMD3 in FIG. 5 is substantially the same as each of the commands CMD1 and CMD3 in FIG. 6.

A program running in the host 50 may access vendor data using the second command CMD2. For example, the second command CMD2 may command reading of the vendor data. The second command CMD2 may include a sector count command 630 including information about the number of sectors to be read from the data storage device 100, and a read command 640. The sector count command 630 may include information about a region of sectors in which the vendor data are written in the vendor mode. The read command 640 may be a command for reading the vendor data stored in the region of sectors.

The second command CMD2 may be determined according to a type of the data storage device 100. For example, when the data storage device 100 is embodied in an eMMC, the sector count command 630 may be CMD23, and the read command 640 may be CMD18. The sector count command 630 may include a first ID ID1 635 which indicates a program capable of accessing vendor data.

Even if it is shown that the sector count command 630 includes the first ID ID1 635 in FIG. 6, the inventive concept is not limited thereto. That is, the first ID ID1 635 may be included in at least one of the sector count command 630 and the read command 640. After a read operation is completed, the data storage device 100 may receive the third command CMD3 from the host 50.

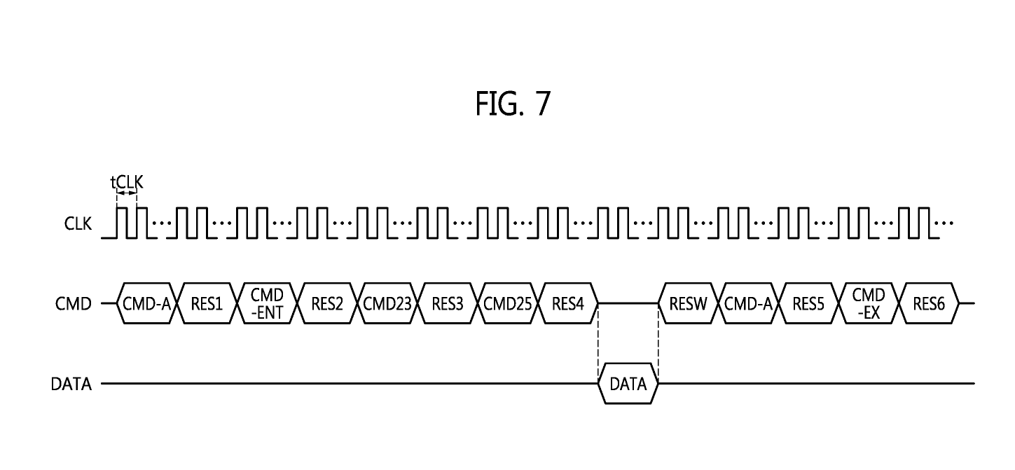

FIG. 7 is a timing diagram of data, a command, and a clock signal received by the data storage device 100 of FIG. 2 in the write operation of FIG. 5. Referring to FIGS. 1, 2, 5, and 7, the host 50 may transmit each of a command CMD and data DATA to the data storage device 100 through different channels. Here, a channel may include at least one transmission line. tCLK shows a cycle of a clock signal CLK. It is assumed that each symbol representing each command shown in FIG. 5 is the same as each symbol representing each command shown in FIG. 7.

The data storage device 100 may receive a clock signal CLK and a command CMD from the host 50, and process data DATA according to the command CMD and the clock signal CLK. For example, the memory controller 120 may write data DATA transmitted from the host 50 in a non-volatile memory, e.g., the flash memory 200, based on the command CMD and the clock signal CLK.

The host 50 may transmit a vendor mode indicating command CMD-A to the data storage device 100 through a command channel for transmitting a command. The data storage device 100 may transmit a first response RES1 corresponding to the vendor mode indicating command CMD-A to the host 50 through the command channel. Moreover, the host 50 may transmit a vendor mode entry command CMD-ENT to the data storage device 100 through the command channel.

The data storage device 100 may transmit a second response RES2 corresponding to the vendor mode entry command CMD-ENT to the host 50 through the command channel. That is, the data storage device 100 may transmit each of responses RES1 to RES6 corresponding to each of commands CMD-A, CMD-ENT, CMD23, CMD25, CMD-A, and CMD-EX transmitted from the host 50 to the host 50. The data storage device 100 may enter a write mode in response to the write command CMD25 transmitted from the host 50, and transmit a fourth response RES4 to the host 50.

The host 50 may transmit write data DATA to the data storage device 100 through a data channel in response to the fourth response RES4. The data storage device 100 may transmit a write response RESW which indicates a completion of a write operation to the host 50 when the write operation of write data DATA is completed. The host 50 may transmit commands CMD-A and CMD-EX for the vendor mode exit (or end) to the data storage device 100 in response to the write response RESW.

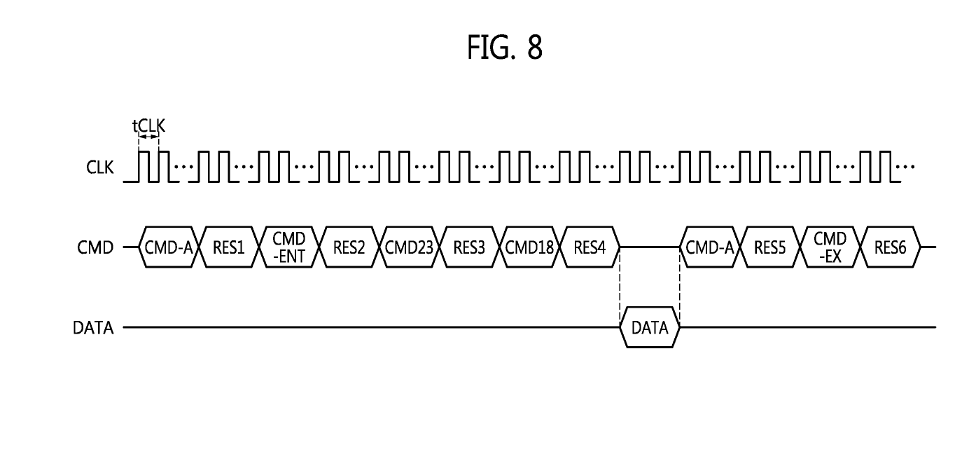

FIG. 8 is a timing diagram of data, a command, and a clock signal received by the data storage device in the read operation of FIG. 6. It is assumed that each symbol which represents each command shown in FIG. 6 is the same as each symbol which represents each command shown in FIG. 8.

Referring to FIGS. 1, 2, 6, and 8, the data storage device 100 may transmit data DATA and a command CMD to the host 50. The data storage device 100 may receive a clock signal CLK and a command CMD from the host 50, and process the data DATA according to the command CMD and the clock signal CKL. For example, the memory controller 120 may transmit the data to the host 50 from the flash memory 200 based on the command CMD and the clock signal CKL.

At a read operation, the data storage device 100 may receive the read command CMD18 after entering the vendor mode. The data storage device 100 may enter a read mode in response to the read command CMD18, and transmit the fourth response RES4 to the host 50 through a command channel. The data storage device 100 may transmit read data DATA to the host 50 through a data channel. After the read operation is completed, the host 50 may transmit the commands CMD-A and CMD-EX for the vendor mode exit (or end) to the data storage device 100.

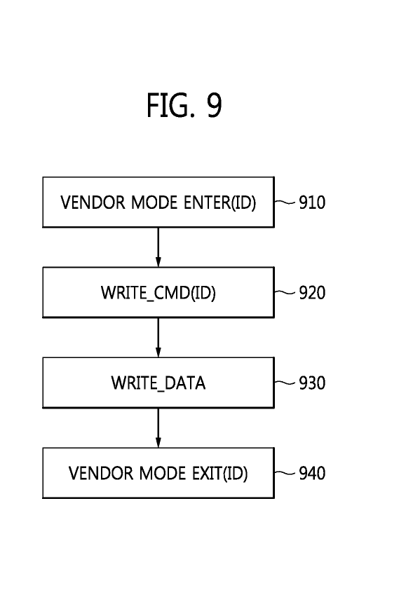

FIG. 9 is a schematic block diagram for a write operation of a data storage device in a vendor mode according to another exemplary embodiment. Referring to FIGS. 1 to 9, the host 50 may transmit a vendor mode entry command VENDOR MODE ENTER to the data storage device 100 (910). The host 50 may insert an ID of a program which can access the first region 210 for accessing vendor data into the vendor mode entry command VENDOR MODE ENTER.

The data storage device 100 may enter the vendor mode in response to the vendor mode entry command VENDOR MODE ENTER. At this time, the data storage device 100 may determine whether there is an ID of a program in the vendor mode entry command VENDOR MODE ENTER, and when it is determined that there is the ID, the data storage device 100 may enter the vendor mode. Accordingly, the program may perform an access operation, e.g., a write operation, for the vendor data.

When the data storage device 100 enters the vendor mode, the host 50 may transmit a write command WRITE_CMD to the data storage device 100 (920). At this time, the data storage device 100 may determine whether there is an ID of a program in the write command WRITE_CMD, and when there is the ID, the data storage device 100 may perform a write mode. In the write mode, a program (that is, a program having the ID) running in the host 50 may transmit write data to the data storage device 100.

The write data may be data to be written in the data storage device 100 by the program. The write data may be transmitted to the data storage device 100 through a write channel. When a write operation is completed, the host 50 may transmit the vendor mode exit command VENROD MODE EXIT to the data storage device 100 (940). At this time, the data storage device 100 may determine whether there is an ID of a program in the vendor mode exit command VENDOR MODE EXIT, and when there is the ID, the data storage device may perform the vendor mode exit (or end).

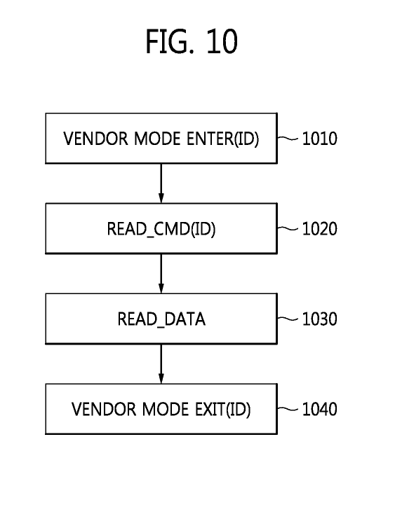

FIG. 10 is a schematic block diagram of a read operation of a data storage device according to another exemplary embodiment. Referring to FIGS. 1 to 10, the host 50 may transmit the vendor mode entry command VENDOR MODE ENTER to the data storage device 100 (1010). The host 50 may insert an ID of a program which can access vendor data into the vendor mode entry command VENDOR MODE ENTER (1010).

The data storage device 100 may enter the vendor mode in response to the vendor mode entry command VENDOR MODE ENTER. At this time, the data storage device 100 may determine whether there is the ID of a program in the vendor mode entry command VENDOR MODE ENTER, and, and when there is the ID, the data storage device 100 may enter the vendor mode.

When the data storage device 100 enters the vendor mode, the host 50 may transmit a read command READ_CMD to the data storage device 100 (1020). At this time, the data storage device 100 may determine whether there is the ID of a program in the read command READ_CMD, and when there is the ID, the data storage device 100 may perform the read mode.

In the read mode, the host 50 may receive read data READ_DATA from the data storage device 100. The read data READ_DATA may be data read from the data storage device by the program. The read data READ_DATA may be transmitted to the host 50 through a data channel.

When the read operation is completed, the host 50 may transmit the vendor mode exit command VENDOR MODE EXIT to the data storage device 100 (1040). At this time, the data storage device 100 may determine whether there is the ID of a program in the vendor mode exit command VENDOR MODE EXIT, and when there is the ID, the data storage device 100 may exit the vendor mode.

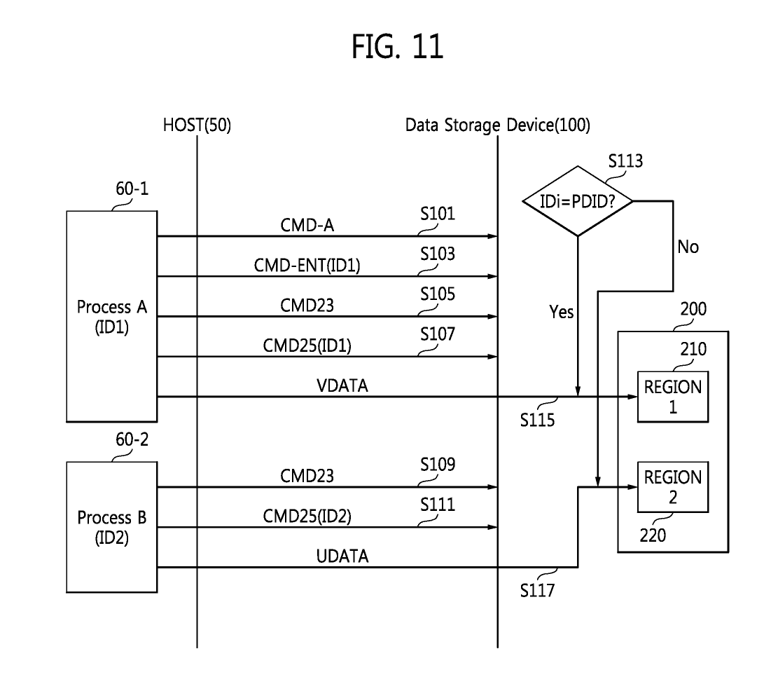

FIG. 11 is a data flow for a write operation of a data storage device according to still another exemplary embodiment.

Referring to FIGS. 1 to 11, each of a process A (60-1) having a first ID ID1 and a process B (60-2) having a second ID ID2 may be a program or an application performed in the host 50, without being limited thereto, and it can be various software programs which can access (or write or read) vendor data stored in the data storage device 100. For example, each of the process A (60-1) and the process B (60-2) may be a program related to a firmware update, an update program for changing a patch file, or a program for defect analysis of the data storage device 100, without being limited thereto.

For example, the process A (60-1) may be a process (or program) for writing vendor data VDATA in the data storage device 100. The process A (60-1) may include the first ID ID1 which indicates the process A (60-1) is a process (or program) that can write the vendor data VDATA.

For example, the process B (60-2) may be a process (or program) for writing user data UDATA in the data storage device 100. The process B (60-2) may include a second ID ID2 which indicates the process B (60-2) is a process (or program) that can write the user data UDATA in the data storage device 100.

For example, the process B (60-2) may be embodied so as not to include the second ID ID2 for identifying the process B (60-2).

The process A (60-1) may transmit a vendor mode indicating command CMD-A to the data storage device 100 to write the vendor data VDATA (S101). The process A (60-1) may transmit the vendor mode entry command CMD-ENT to the data storage device 100 (S103). At this time, the vendor mode entry command CMD-ENT may include the first ID ID1 for identifying the process A (60-1) (S103).

Even if it is shown that the first ID ID1 is included in the vendor mode entry command CMD-ENT in FIG. 11, the inventive concept is not limited thereto, and the first ID ID1 may be included in at least one of the vendor mode indicating command CMD-A and the vendor mode entry command CMD-ENT.

The data storage device 100 may determine whether there is the first ID ID1 of the program A (60-1) in at least one of the vendor mode indicating command CMD-A and the vendor mode entry command CMD-ENT, and when there is the first ID ID1, the data storage device may enter the vendor mode.

After the data storage device 100 enters the vendor mode, the process A (60-1) may transmit the sector count command CMD23 for a region in which the vendor data VDATA are to be written to the data storage device 100 (S105). The process A (60-1) may transmit the write command CMD25 to the data storage device 100 (S107). The write command CMD23 may include the first ID ID1 of the process A (60-1).

Even if it is shown that the first ID ID1 is included in the write command CMD25 in FIG. 11, the inventive concept is not limited thereto, and the first ID ID1 may be included in at least one of the sector count command CMD23 and the write command CMD25.

The data storage device 100 may compare a first ID IDi=ID1 included in each of the command CMD-ENT and CMD25 with a reference ID PDID set in advance (S113). At this time, it is assumed that the reference ID PDID is set to be the same as the first ID Idi=ID1.

When the first ID Idi=ID1 accords with the reference ID PDID (YES in S113), the process A (60-1) may access the first region 210 of the flash memory 200 (S115). That is, the process A (60-1) may write the vendor data VDATA to the first region 210.

After the data storage device 100 enters the vendor mode, the process B (60-2) may transmit the sector count command CMD23 to the data storage device 100 (S109). The process B (60-2) may transmit the write command CMD25 to the data storage device 100 (S111). At this time, the write command CMD23 may include the second ID ID2 of the process B (60-2) or may not include the second ID ID2.

The data storage device 100 compares the second ID IDi=ID2 and the reference ID PDID. When the second ID IDi=ID2 does not accord with the reference ID PDID (No in S113), the data storage device 100 may reject an access of the process B (60-2) to the first region 210, and may allow an access to a second region 220 (S117). That is, the process B (60-2) may write user data UDATA to the second region 220. Accordingly, the data storage device 100 may prevent the vendor data stored in the first region 210 from being changed by the process B (60-2). For example, an input ID IDi can be compared with the reference ID PDID by the control logic circuit 140 or the firmware 150 performed by the control logic circuit 140.

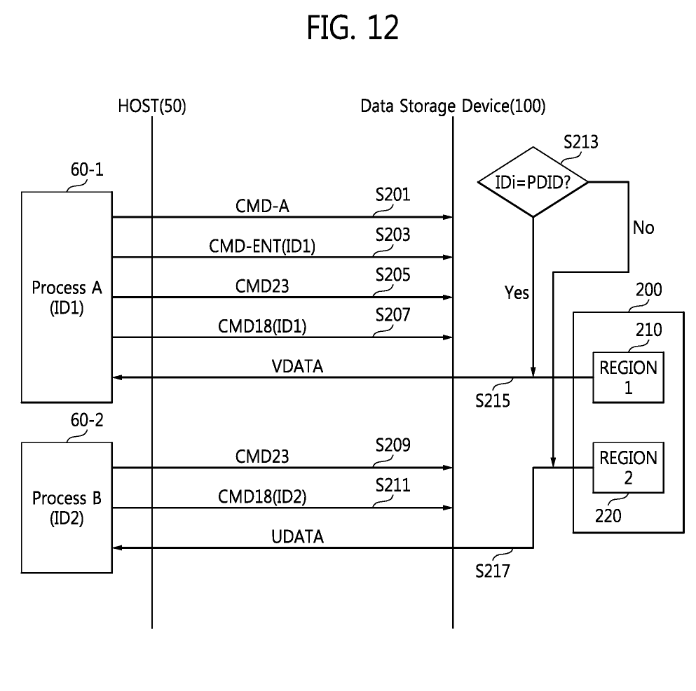

FIG. 12 is a data flow for a read operation of a data storage device in the vendor mode according to still another exemplary embodiment. Referring to FIGS. 1 to 12, the process A (60-1) having a first ID ID1 may be a process (or program) for reading vendor data VDATA from the data storage device 100. The process A (60-1) may include the first ID ID1 for identifying the process A (60-1).

The process B(60-2) having a second ID ID2 may be a process (or program) for reading user data UDATA form the data storage device 100. The process B (60-2) may include a second ID ID2 for identifying the process B (60-2). Moreover, the process B (60-2) may be embodied so as not to include the second ID ID2.

The process A (60-1) may transmit the vendor mode indicating command CMD-A to the data storage device 100 so as to read the vendor data VDATA from the data storage device 100 (S201). The process A (60-1) may transmit the vendor mode entry command CMD-ENT to the data storage device 100 (S203). At this time, the vendor mode entry command CMD-ENT may include the first ID ID1 of the process A (60-1) (S203).

Even if it is shown that the first ID ID1 is included in the vendor mode entry command CMD-ENT in FIG. 12, the inventive concept is not limited thereto, and the first ID ID1 may be included in at least one of the vendor mode indicating command CMD-A and the vendor mode entry command CMD-ENT.

The data storage device 100 may determine whether there is the first ID ID1 of the program A (60-1) in at least one of the vendor mode indicating command CMD-A and the vendor mode entry command CMD-ENT, and when there is the first ID ID1, the data storage device 100 may enter the vendor mode. After the data storage device 100 enters the vendor mode, the process A (60-1) may transmit the sector count command CMD23 for a region in which the vendor data VDATA are stored to the data storage device 100 (S205). The process A (60-1) may transmit the read command CMD18 to the data storage device 100 (S207). The read command CMD18 may include the first ID ID1 of the process A (60-1).

Even if it is shown that the first ID ID1 is included in the read command CMD18 in FIG. 12, the technical concept is not limited thereto, and the first ID ID1 may be included in at least one of the sector count command CMD23 and the read command CMD18.

The data storage device 100 may compare the first ID IDi=ID1 included in the read command CMD18 and the reference ID PDID (S213). At this time, it is assumed that the reference ID PDID is set to be the same as the first ID IDi=ID1.

When the first ID IDi=ID1 accords with the reference ID PDID (Yes in S213), the process A (60-1) may access the first region 210 of the flash memory 200 (S215). That is, the process A (60-1) may read the vendor data VDATA from the first region 210.

After the data storage device 100 enters the vendor mode, the process B (60-2) may transmit the sector count command CMD23 to the data storage device 100 (S209). Moreover, the process B (60-2) may transmit the read command CMD18 to the data storage device 100 (S211). At this time, the read command CMD18 may or may not include a second ID ID2 of the process B (60-2).

The data storage device 100 may compare the second ID IDi=ID2 and the reference ID PDID (S213), and when the second ID IDi=ID2 does not accord with the reference ID PDID, the data storage device 100 may reject an access of the process B (60-2) to the first region 210 and allow an access to the second region 220 (S217). That is, the process B (60-2) may read user data UDATA from the second region 220. Accordingly, the data storage device 100 may prevent vendor data stored in the first region 210 from being read by the process B (60-2). For example, an input ID (IDi) can be compared with the reference ID PDID by the control logic circuit 140 or the firmware 150 performed by the control logic circuit 140.

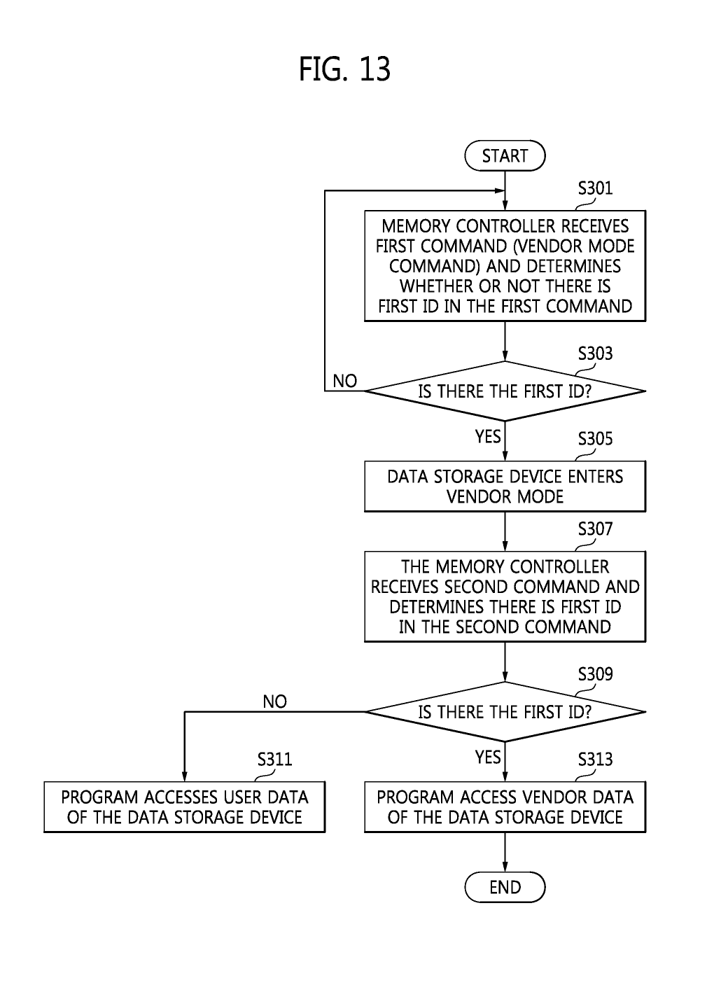

FIG. 13 is a flow chart which shows an exemplary embodiment of a method of operating the data storage device according to an exemplary embodiment. Referring to FIGS. 1 to 13, the host 50 may transmit the first command CMD1 to the data storage device 100 so as to access vendor data.

The memory controller 120 may receive the first command CMD1 and determine whether there is a first ID in the first command CMD1 (S301). When there is not the first ID ID1 in the first command CMD1 (No in S303), the data storage device 100 may not enter the vendor mode. When there is the first ID ID1 in the first command CMD1 (Yes in S303), the memory controller 120 may control so that the data storage device 100 enters the vendor mode (S305).

When the data storage device 100 enters the vendor mode (S305), the memory controller 120 may receive the second command CMD2 (S307). The memory controller 120 may determine whether there is a first ID in the second command CMD2 before performing the second command CMD2 (S307). When there is not the first ID ID1 in the second command CMD2 (No in S309), the data storage device 100 does not allow a program running in the host 50 to access vendor data (S311). However, when there is the first ID ID1 in the second command CMD2 (Yes in S309), the data storage device 100 allows the program running in the host 50 to access the vendor data (S313).

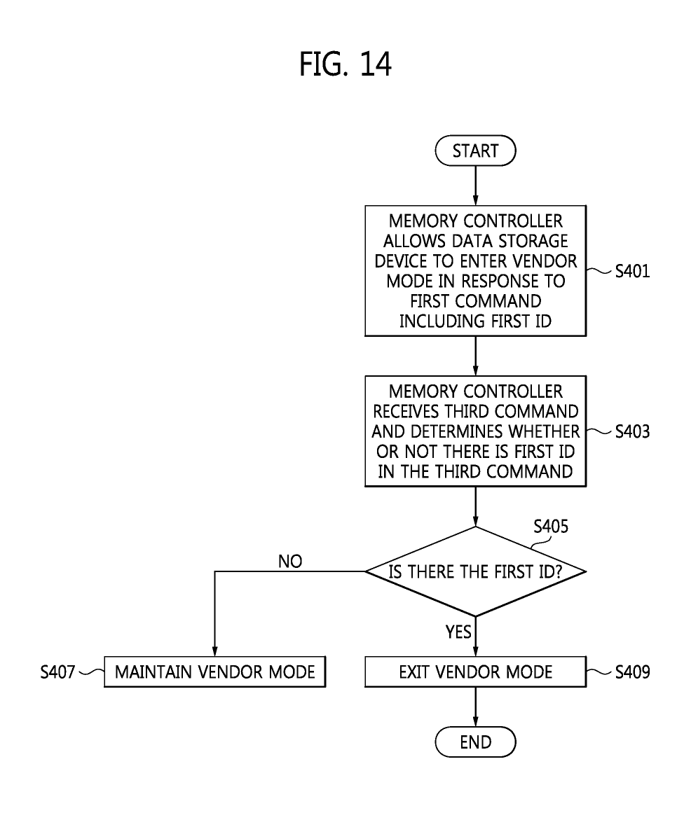

FIG. 14 is a flow chart which shows another exemplary embodiment of the method of operating the data storage device according to an exemplary embodiment. Referring to FIGS. 1 to 14, the memory controller 120 allows the data storage device 100 to enter the vendor mode in response to the first command CMD1 including the first ID ID1 (S401).

When the data storage device 100 is in the vendor mode, the memory controller 120 may receive the third command CMD3 for a vendor mode exit, and determine whether there is the first ID ID1 in the third command CMD3 (S403). When there is not the first ID ID1 in the third command CMD3 (S405), the data storage device 100 may maintain the vendor mode (S407). When there is the first ID ID1 in the third command CMD3 (S405), the data storage device 100 may exit the vendor mode (S409).

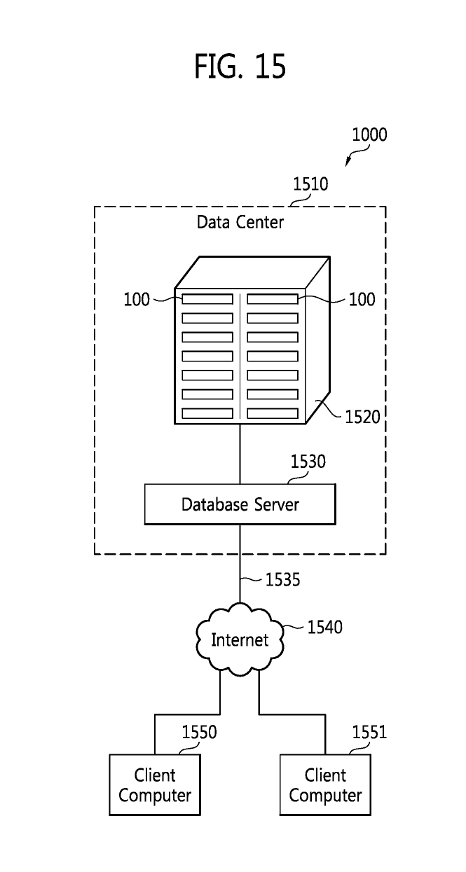

FIG. 15 is a block diagram of a data processing system according to another exemplary embodiment. Referring to FIGS. 1 to 15, a data processing system 1000 may include a database 1520, a database server 1530, a second network 1540, and a plurality of client computers 1550 and 1551. The database 1520 and the database server 1530 may be included in a data center, an internet data center, or a cloud data center 1510.

The database 1520 may include a plurality of data storage devices 100. The plurality of data storage devices 100 may be installed in a rack. A structure and an operation of each data storage device 100 are substantially the same as or similar to a structure and an operation of the data storage device 100 described referring to FIGS. 1 to 14.

The database server 1530 may control an operation of each of the plurality of data storage devices 100. The database server 1530 may be connected to the second wireless network 1540, e.g., the internet or WiFi, through a first network 1535, for example, a local area network (LAN). Each of the plurality of client computers 1550 and 1551 may be connected to the database server 1530 through the second network 1540.

A data storage device according to an exemplary embodiment may use an ID of a process which can enter a vendor mode and allow only the process having the ID to use a vendor mode service. Accordingly, the data storage device may prevent a process which cannot enter the vendor mode from using the vendor mode service. The data storage device may distinguish a process which can access a memory region for storing vendor data from a process which cannot access the memory region, in a multi-process environment.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data storage device comprising:
a non-volatile memory which comprises a first region configured to store vendor data and a second region configured to store user data; and
a memory controller configured to receive a first command from a host, determine whether there is a first identification (ID) of a program, which is allowed to access the first region, in the first command, and decide whether to enter a vendor mode for accessing the first region according to a result of the determination.

2. The data storage device of claim 1, wherein the first command comprises a vendor mode indicating command and a vendor mode entry command, and the first ID is included in one of the vendor mode indicating command and the vendor mode entry command.

3. The data storage device of claim 1, wherein the memory controller is further configured to receive a second command from the host, determine whether there is the first ID of the program in the second command, and decide whether to allow access of the program to the first region according to a result of the determination.

4. The data storage device of claim 3, wherein the second command includes a sector count command comprising information about a number of sectors to be written and a write command, and the first ID is included in one of the sector count command and the write command.

5. The data storage device of claim 4, wherein the vendor data comprises data required for at least one of updating a patch file stored in the data storage device, updating firmware stored in the data storage device, and failure analysis of the data storage device.

6. The data storage device of claim 3, wherein the memory controller is further configured to write first data generated by the program in the first region in response to determining that there is the first ID of the program in the second command, and,
wherein the memory controller is configured to write the first data in the second region in response to determining that there is not the first ID of the program in the second command.

7. The data storage device of claim 3, wherein the second command comprises a sector count command comprising information about a number of sectors to read and a read command, and the first ID is included in one of the sector count command and the read command.

8. The data storage device of claim 7, wherein the vendor data comprises data required for at least one of updating a patch file stored in the data storage device, updating firmware stored in the data storage device, and a failure analysis of the data storage device.

9. The data storage device of claim 3, wherein the memory controller is further configured to read the vendor data stored in the first region according to a read command generated by the program, and transmit the read vendor data to the host in response to determining that there is the first ID of the program in the second command, and
wherein the memory controller is further configured to transmit the user data stored in the second region to the host according to the read command in response to determining that there is not the first ID of the program in the second command.

10. The data storage device of claim 1, wherein the program is a program related to at least one of a firmware update of the data storage device, a patch file update of the data storage device, and a failure analysis of the data storage device.

11. The data storage device of claim 1, wherein the memory controller is further configured to receive a second command from the host, determine whether there is the first ID of the program which is allowed to access the first region in the second command, and decide whether to exit the vendor mode according to a result of the determination.

12. The data storage device of claim 11, wherein the first command comprises a vendor mode indicating command and a vendor mode exit command, and the first ID is included in one of the vendor mode indicating command and the vendor mode exit command.

13. The data storage device of claim 1, wherein the data storage device further comprises a memory configured to store a second ID, and the memory controller is configured to decide whether to enter the vendor mode in response to determining that the first ID accords with the second ID stored in the memory.

14. A data storage device comprising:
a memory comprising a first region configured to store vendor data and a second region configured to store user data; and
a memory controller configured to receive a command generated from a process or program performed by a host connected to the data storage device, determine an attribute of the command, and selectively allow an access of the command to the first region or the second region depending on a result of the determination of the attribute of the command.

15. The data storage device of claim 14, wherein the command is one of a read command for reading data stored in the first region or the second region or a write command for writing data to the first region or the second region.

16. The data storage device of claim 14, wherein the attribute of the command comprises an identification (ID) of the process or program.

17. The data storage device of claim 14, wherein, in order to determine the attribute of the command, the memory controller is configured to compare the attribute with information about the process or program prestored in the memory controller.

18. The data storage device of claim 14, wherein, in response to determining that the attribute of the command indicates that the process or program is not allowed to access the first region for accessing the vendor data, the memory controller is configured not to allow the command to access the first region.

19. A data processing system comprising:
a host; and
a data storage device which is connected to the host,
wherein the data storage device includes:
a non-volatile memory device which comprises a first region configured to store vendor data and a second region configured to store user data; and
a memory controller configured to receive a first command from the host, determine whether there is a first identification (ID) of a program, which is allowed to access the first region in the first command, and decide whether to enter a vendor mode for accessing the first region according to a result of the determination.

20. The data processing system of claim 14, wherein the first command comprises a vendor mode indicating command and a vendor mode entry command, and the first ID is included in one of the vendor mode indicating command and the vendor mode entry command.
